(19) United States
(12) Patent Application Publication
(10) Pub. No.: US 2009/0013171 A1
(43) Pub. Date: Jan. 8, 2009

(54) COMPUTER DOCKING SYSTEM USING HARDWARE ABSTRACTION

(75) Inventor: Erik Gilling, San Francisco, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/189,687

(22) Filed: Aug. 11, 2008

Related U.S. Application Data
(63) Continuation-in-part of application No. 11/523,242, filed on Sep. 19, 2006.
Application No. 11/523,242 is a continuation-in-part of application No. 11/367,246, filed on Mar. 2, 2006.

(51) Int. Cl. G06F 1/24

(52) U.S. Cl. 713/100

(57) ABSTRACT

One embodiment uses a virtual machine layer between software and hardware on both a portable computing device and on a docking station used by the portable computing device. A first virtual machine layer on the portable device is used to save the state of the portable device upon intermediate shutdown. Upon docking the portable device with the docking station, a second virtual machine layer on the docking station is loaded with the state of the first virtual machine. The second virtual machine layer is aware of the resources in the docking station and is programmed to utilize the docking station resources (and the portable computing device resources, as desired) to restore and continue the state while allowing the operating system, application programs and other software and hardware to utilize the resources of the docking station.

### CLAIM OF PRIORITY

This application is a continuation-in-part of co-pending U.S. patent application Ser. No. 11/523,242 entitled “MODULAR COMPUTING SYSTEM,” filed on Sep. 19, 2006; which is hereby incorporated by reference as if set forth in full in this application for all purposes.

This application is a continuation-in-part of co-pending U.S. patent application Ser. No. 11/367,246 entitled “MODULAR COMPUTING SYSTEM,” filed on Mar. 2, 2006; which is hereby incorporated by reference as if set forth in full in this application for all purposes.

### BACKGROUND

One typical approach to computing provides a user with a local computer system. The local computer system can include local computing resources such as processing power, storage capacity, bandwidth for data transfers, output capability (e.g., display, audio speakers, etc.), input capability (e.g., keyboard, mouse, touch screen, camera, gesture recognition, etc.), display and other resources.

When a computing system is made significantly small, such as notebook computer, sub-notebook, ultra-portable, handheld, etc. types of portable computing devices, it often means that the computing resources included in the device are more limited than larger computing systems, such as desktop computers. One approach to allow a portable device to use additional larger, faster or more complex resources is to provide a “docking station” to which the portable device can be attached, or brought into proximity with (e.g., to communicate via wireless connections), so that the portable computing device can use the resources of the docking station.

For example, a docking station can provide a larger display, full-size keyboard, larger hard disk drive, more random access memory (RAM), additional software, operating system utilities, graphics accelerator, faster network connections, etc. Any one or more resources may be provided by a docking station. For example, a docking station may merely provide a standard wired power connection to the power grid. When the portable device is docked it may use the docking station resources. When the portable device is undocked it can operate with its local, self-contained resources in a compact and portable manner.

The process of docking a portable device to a docking station usually means that the portable device must be shut down to a powered off state so that the operating system can boot anew and detect and use the external resources provided by the docking station. This is a drawback since a hard shutdown and restart can take up to a few minutes and any software applications that were being used must be re-started and loaded with data (e.g., a word-processing document opened and navigated to its former location; a spreadsheet opened and settings reset; web browser launched, web page navigated to and selections made; etc.). In some cases it may be difficult, time-consuming or not possible (e.g., web-page has been updated, or removed) to return an application to a state that it was in when a user was operating it before the shutdown.

Most computing devices now provide “shutdown” modes that do not require a complete power shutdown (“hard shutdown”). These intermediate shutdown modes such as “standby,” “hibernate,” “sleep,” etc. each attempt to save the state of all or a part of a computing device so that the operating system and application programs can be returned to their former states where the user may continue to work with the applications as they were just prior to the intermediate shutdown. One problem with this approach is that the intermediate shutdown and restoration assumes that the hardware will be the same, or substantially the same, as before the intermediate shutdown so that new resources that may be provided by a docking station will not be used effectively, if at all. Or the restoration of the intermediate shutdown mode will fail and the computing device will have to be subjected to a hard shutdown and power-on, in which case the state data is lost and the applications and operating system must be manually set back to their prior states, if possible.

### SUMMARY

One embodiment uses a virtual machine layer between software and hardware on both a portable computing device and on a docking station used by the portable computing device. A first virtual machine layer on the portable device is used to save the state of the portable device upon intermediate shutdown. Upon docking the portable device with the docking station, a second virtual machine layer on the docking station is loaded with the state of the first virtual machine. The second virtual machine layer is aware of the resources in the docking station and is programmed to utilize the docking station resources (and the portable computing device resources, as desired) to restore and continue the state while allowing the operating system, application programs and other software and hardware to utilize the resources of the docking station.

In one embodiment the invention provides a method for bringing a computing device out of a hibernation mode, the method comprising: detecting that the computing device is in communication with new resources that were not available at a time of placing the computing device into the hibernation mode; creating a virtual machine layer in communication with the new resources; copying at least a portion of state data saved prior to a time of the computing device entering the hibernation mode; using the state data with the virtual machine layer to restore a state of a saved operating system, wherein the saved operating system was executing on the computing device prior to the time of the computing device entering the hibernation mode; and executing the restored operating system, wherein the executing includes using the new resources.

### BRIEF DESCRIPTION OF THE DRAWINGS

FIG. 1 shows resources in a portable device and in a docking station.

### DETAILED DESCRIPTION OF EMBODIMENTS OF THE INVENTION

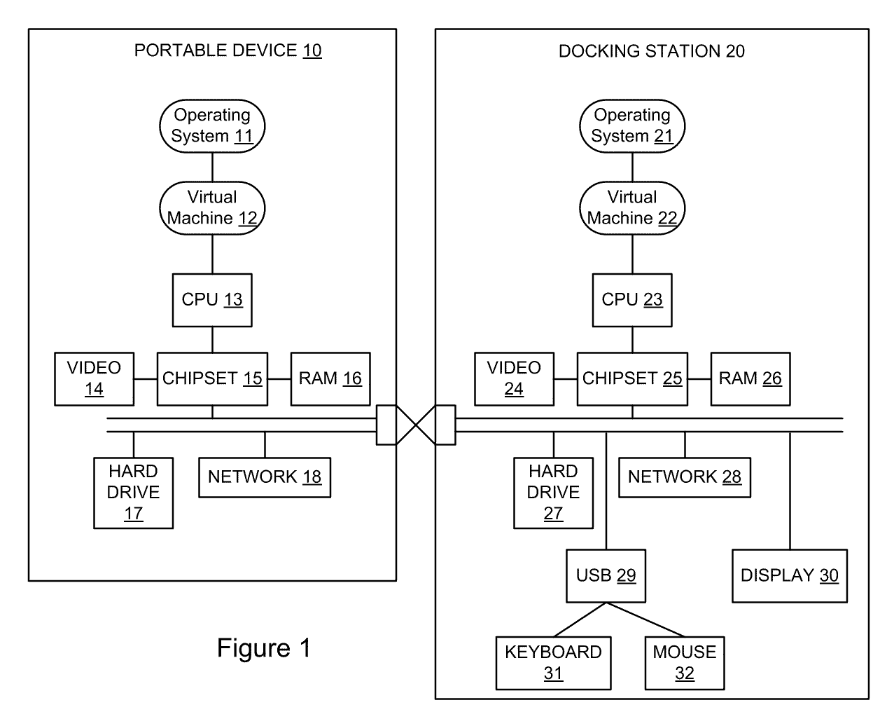

FIG. 1 illustrates subsystems and processes in portable computing device 10 docked to docking station 20. It should be apparent that any type of computing device having a first set of resources that is capable of being docked to, or in communication with, another computing device having a second set of resources may be suitable for use with embodiments of the invention.

Portable computing device 10 includes processes such as operating system 11 and virtual machine 12. For purposes of discussion, application programs can be considered to be executing along with operating system 11 while low-level processes and utilities such as device drivers can be considered to be executing in communication with virtual machine 12.

Virtual machine 12 acts as an interface or layer between operating system 11 and the hardware and firmware resources of the portable device. Central processing unit (CPU) 13 communicates with various other local hardware in a known manner as, for example, across internal or system buses. CPU 13 and other hardware such as video processor 14, motherboard chipset 15, random-access memory (RAM) 16, hard drive 17 and network interconnection 18.

Once docked, the resources of portable device 10 are in communication with resources of docking station 20 via a communication link such as bus 40 that includes parts 40a and 40b. Bus 40 can be a bus dedicated for docking station transactions or it can be a general purpose communication interface such as a Universal Synchronous Bus (USB), Ethernet, PCMCIA interface, 802.11x, Bluetooth, or any other suitable type of communication link.

Docking station 20 includes its own resources such as operating system 21, virtual machine 22, CPU 23, video processor 24, chipset 25, RAM 26, hard drive 27, network interface 28, USB interface 29, display 30, keyboard 31 and mouse 32. These resources are different from those of the portable device, described above.

Prior to docking, the portable device is put into an intermediary shutoff state, such as hibernation. In hibernation the operating system, application and other data in RAM and on the hard drive in the executing system is stored to the hard drive in a format for later restoration of the system. When the system is turned on from hibernation, the state information is copied back from the hard drive into the RAM and to portions of the hard drive and the state information is restored so that execution can continue essentially the same as before the hibernation occurred. However, this assumes that the hardware configuration and other resources of the device have not changed since hibernation was entered.

In one embodiment of the invention, virtual machine 12 acts as a layer between the operating system (and, hence, the applications, which run under the operating system) to provide the operating system with access to the various resources. For example, virtual machine 12 can inform the operating system of a particular interface for a graphics accelerator (e.g., video processor 14). An application such as a game that executes under operating system 12 can provide image data to the virtual machine for transfer to the video processor. The interface to the operating system can be identical or similar to the interface the operating system would have in a case where the virtual machine was not present and the operating system communicates directly with the drivers and interface provided by a manufacturer of the graphics accelerator. Or the interface can be a different type and the virtual machine can perform translations of data and commands in acting as an intermediary between the operating system and the graphics accelerator. In a similar manner, the various other resources of the portable device are in communication with the operating system and applications via virtual machine 12.

Embodiments of the invention can be used with the modular computing architecture described in the co-pending patent applications referenced above. For example, one or more modules can act as the portable device and one or more other modules may function as the docking station so that new resources are provided to a first set of modules by a second set of modules. The first set of modules can be placed in an intermediate shutoff mode with a saved state and then restored to the saved state while utilizing the new resources according to the method and system described herein.

The following scenario assumes that portable device 10 has been put in an intermediate shutdown mode, such as hibernation, so that the state of operation of the portable device 10 is saved in hard drive 17. Then, portable device 10 is placed into communication with docking station 20 while still in hibernation. After communication is established between portable device 10 and docking station 20 (e.g., via bus 40) the following actions take place in order to restore the state of the portable device from hibernation while using at least some of the resources of the docking station.

First, the virtual machine executable is copied from virtual machine 12 to virtual machine 22. The virtual machine executable is stored in a non-volatile memory such as in hard drive 17 as part of, or along with, the operating system state as part of hibernation. Alternatively, a virtual machine kernel and associated processes can be included in read-only memory as part of a basic input-output operating system (BIOS) or as part of a utility that is provided by the manufacturer of the portable device.

Second, other content needed by virtual machine 22 is obtained and transferred to restore the state of virtual machine 12 to virtual machine 22 while also accounting for additional resources of the docking station. For example, since video processor 24 and display 30 are now available, virtual machine 22 determines that video processor 1 had been previously in use and compares the desirability of using video processor 24 with video processor 14. The decision to use resources of the docking station in addition to or in place of the resources in the portable computer can be made with any of a number of factors. For example, factory settings in the portable device and/or the docking station can be used. Or user's can be allowed to select which resources or combinations of resources to use. Another approach can use virtual machine 22 to determine which resources or combinations of resources would be most effective.

The resource determination and use can take into account any of the resources made newly-available due to docking the portable device to the docking station. The speed and capacity of hard disk drives, processor speed, network connection bandwidth; chipset speed, power consumption, and other characteristics can be considered.

Once virtual machine 22 has been instated it is executed to copy the operating system state from hard drive 17 to hard drive 27 (if needed) and RAM 26 to create an executable image as operating system 21. Finally, the operating system 21 is executed and now communicates through virtual machine 22 to use resources that can be any combination of the portable device resources or the docking station resources.

Although specific embodiments of the invention have been described, variations of such embodiments are possible and are within the scope of the invention.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method for bringing a computing device out of a intermediate shutoff mode, the method comprising:
detecting that the computing device is in communication with new resources that were not available at a time of placing the computing device into the intermediate shutoff mode;
creating a virtual machine layer in communication with the new resources;
copying at least a portion of state data saved prior to a time of the computing device entering the intermediate shutoff mode;
using the state data with the virtual machine layer to restore a state of a saved operating system, wherein the saved operating system was executing on the computing device prior to the time of the computing device entering the intermediate shutoff mode; and
executing the restored operating system, wherein the executing includes using the new resources.

2. A method for restoring a state of a computing device, the method comprising:
loading at least a portion of the state of the computing device into a system that includes at least one new resource that was not in communication with the computing device when the at least a portion of the state of the computing device was saved;
using the loaded at least a portion of the state to restore at least a portion of an operating system;
using a virtual machine layer to communicate between the restored at least a portion of the operating system and the at least one new resource.
